(19) United States
(12) Patent Application Publication
(10) Pub. No.: US 2017/0066895 A1
(43) Pub. Date: Mar. 9, 2017

(54) Rubber Composition for an Airless Tire Tube and Method for Producing the Same

(71) Applicant: Peram LLC, Lancaster, PA (US)

(72) Inventor: Minh Hung Dinh, Ho Chi Minh City (VN)

(73) Assignee: Peram LLC, Lancaster, PA (US)

(21) Appl. No.: 15/061,195

(22) Filed: Mar. 4, 2016

Related U.S. Application Data
(60) Provisional application No. 62/215,890, filed on Sep. 9, 2015.

(51) Int. Cl. C08J 9/14; C08J 9/12

(52) U.S. Cl. CPC C08J 9/142; C08J 9/127; C08J 2323/16; C08J 2325/10; C08J 2407/00; C08J 2425/10; C08J 2419/00; C08J 2309/00; C08J 2425/06

(57) ABSTRACT

A rubber composition is provided and includes a first elastomer, a second elastomer, carbon black, a plasticizer, a blowing agent, and a filler. The first elastomer is provided in a range of 15.97-34.71 wt %, while the second elastomer is provided in a range of of 8.37-16.22 wt %. Carbon black is provided in the range of 13.29-23.00 wt %. The plasticizer is provided in a range of 13.71-20.02 wt %, and the blowing agent is provided in a range of 3.22-5.11 wt %. The filler is provided to complete the composition.

### CROSS-REFERENCE TO RELATED APPLICATIONS

This application claims the benefit of the filing date under 35 U.S.C. §119(a)-(d) of U.S. Provisional Patent Application No. 62/215,890 filed Sep. 9, 2015.

### FIELD OF THE INVENTION

The present invention relates to a rubber composition and, in particular, to a rubber composition for an airless tire tube.

### BACKGROUND

In general, a tire is an essential component for many vehicles, including a bicycle. The tire comes into direct contact with the road surface and provides traction and shock absorption by holding air therein. A bicycle tire requires an air-filled tube to maintain air pressure and provide a consistent ride quality along uneven road surfaces. However, these air-filled tubes often fail or release air pressure causing unimproved ride quality or an inability to use the tire.

While airless or solid tire are known, many are bulky, heavy, and lack the feel of an air-filled tire. Considering that many bicycle enthusiasts like the feel of the air-filled tire tube, there has been a need for an airless tire tube that weighs and feels like an air-filled tire tube.

### SUMMARY

The present invention was made in view of the above-mentioned issues and is directed toward a rubber composition for an airless tire tube.

Accordingly, a rubber composition is provided and includes a first elastomer, a second elastomer, carbon black, a plasticizer, a blowing agent, and a filler. The first elastomer is provided in a range of 15.97-34.71 wt %, while the second elastomer is provided in a range of 8.37-16.22 wt %. Carbon black is provided in the range of 13.29-23.00 wt %. The plasticizer is provided in a range of 13.71-20.02 wt %, and the blowing agent is provided in a range of 3.22-5.11 wt %. The filler is provided to complete the composition.

### DETAILED DESCRIPTION OF THE EMBODIMENT(S)

The invention is a rubber composition for airless tire tubes that has desirable material properties, such as durability, weight, and feel required for substitution with an air-filled tire tube.

The rubber composition according to the invention includes a first elastomer, a second elastomer, carbon black, a plasticizer, one or more blowing agents, and a filler.

In an exemplary embodiment of the invention, the rubber composition includes a proportion of 15.97-34.71 wt % of a first elastomer, 8.37-16.22 wt % of a second elastomer, 13.29-23.00 wt % of carbon black, 13.71-20.02 wt % of a plasticizer, 3.22-5.11 wt % of a blowing agent; a filler and incidental impurities complete the balance of the composition.

In particular, in an exemplary embodiment of the invention, the rubber composition includes a combination of elastomers. More particularly, the rubber composition includes a combination of saturated and unsaturated rubbers. In the described embodiment, the rubber composition includes a combination of the following group of elastomers, including ethylene propylene diene monomer rubber (EPDM), natural polyisoprene rubber, chloroprene rubber (CR), styrene-butadiene rubber (SBR), and nitrile rubber (NBR). However, one skilled in the art should appreciate that a combination of other saturated and unsaturated rubbers may be possible.

In the proposed rubber composition, an elastomer, such as EPDM, is used to enhance heat-, ozone-, and weather-resistance, as well as electrical insulating properties. In the proposed rubber composition, an addition of a second elastomer, such as, natural polyisoprene rubber, is used to enhance elasticity of the rubber composition.

In particular, in an exemplary embodiment of the invention, the rubber composition includes a first elastomer having a wt % range of 15.97-34.71%. In another exemplary embodiment of the invention, the rubber composition includes a first elastomer having a wt % range of 15.97-20.73%. In yet another exemplary embodiment of the invention, the rubber composition includes a first elastomer having a wt % range of 20.47-20.73%.

In particular, in an exemplary embodiment of the invention, the rubber composition includes the second elastomer having a wt % range of 8.37-16.22%. In another exemplary embodiment of the invention, the rubber composition includes the second elastomer having a wt % range of 11.46-16.22%.

In the proposed rubber composition, carbon black is used as a pigment and reinforcing material. Also, the carbon black can be used to reduce thermal damage and product viability.

In particular, in an exemplary embodiment of the invention, the rubber composition includes carbon black having a wt % range of 13.29-23.00%. In another exemplary embodiment of the invention, the rubber composition includes carbon black having a wt % range of 22.41-22.80%. And, in yet another exemplary embodiment of the invention, the rubber composition includes carbon black having a wt % of 22.53%.

In the proposed rubber composition, one or more plasticizers are used to increase the plasticity. In the proposed rubber composition, one or more plasticizers is also used a softener, extender, and lubricant for manufacturing of product from the rubber composition, including an airless tube for a tire. In particular, in an exemplary embodiment of the invention, the rubber composition may include a combination of plasticizers, including paraffinic oil and stearic acid.

In particular, in an exemplary embodiment of the invention, the rubber composition includes one or more plasticizers having a wt % range of 13.71-20.02%. In another exemplary embodiment of the invention, the rubber composition includes plasticizer having a wt % range of 19.00-20.02%. And, in yet another exemplary embodiment of the invention, the rubber composition includes one or more plasticizers having a wt % of 19.88%.

In the proposed rubber composition, one or more blowing agents may be used to produce a cellular structure that reduces density, increases thermal and acoustic insulation, and increases relative stiffness. In particular, in an exemplary embodiment of the invention, the rubber composition may include one or more blowing agents, including calcium oxide (CaO) and azodicarbonamide (ACD).

In an exemplary embodiment of the invention, the rubber composition includes one or more blowing agents having a wt % range of 3.22-5.11%. In another exemplary embodiment of the invention, the rubber composition includes one or more blowing agents having a wt % range of 3.53-3.55%. And, in yet another exemplary embodiment of the invention, the rubber composition includes one or more blowing agents having a wt % of 3.54%.

In the proposed rubber composition, filler is used to complete the composition with respect to the other parts. In particular, in an exemplary embodiment of the invention, the rubber composition may include calcium carbonate as a filler. In the proposed rubber composition, calcium carbonate may have a wt % range of 15.97-17.48%. In another exemplary embodiment of the invention, the rubber composition includes filler having a wt % range of 15.97-16.22%.

The rubber composition according to the invention also includes a curing agent and an antioxidant agent.

In another exemplary embodiment of the invention, the proposed rubber composition includes a proportion of 15.97-34.71 wt % of a first elastomer, 8.37-16.22 wt % of a second elastomer, 13.29-23.00 wt % of carbon black, 13.71-20.02 wt % of a plasticizer, 3.22-5.11 wt % of a blowing agent, 5.57-6.71 wt % of a curing agent, 0.15-0.44 wt % of an antioxidant, and filler completing the composition.

In the proposed rubber composition, the curing agent is used to toughen or harden the overall composition by cross-linking of polymer chains, using processes such as vulcanization. In an exemplary embodiment of the invention, the rubber composition may include one or more curing agents, including zinc oxide, n-cyclohexyl-2-benzothiazole sulfenamide (CBS), diphenylguanidine (DPG), and sulfur (S).

In the proposed rubber composition, one or more curing agents may have a wt % range of 5.57-6.71%. In another exemplary embodiment of the invention, the rubber composition includes one or more curing agents having a wt % range of 5.57-5.62%.

In the proposed rubber composition, the antioxidant is used to prevent oxidation. In an exemplary embodiment of the invention, the rubber composition may include one or more antioxidants, including butylated hydroxytoluene (BHT) and/or 2,2,4-trimethyl-1,2-dihydroquinoline polymer (TMQ).

In the proposed rubber composition, one or more antioxidants may have a wt % range of 0.15-0.44%. In another exemplary embodiment of the invention, the rubber composition includes one or more antioxidants having a wt % range of 0.15-0.17%. In yet another exemplary embodiment of the invention, the rubber composition includes one or more antioxidants having a wt % range of 0.42-0.44%.

The present invention can be illustrated by the following examples without being limited by them. Each of the following examples was prepared being dependent on a required size of the airless tire tube according to the invention.

Table 1 shows an exemplary embodiment of the rubber composition.

TABLE 1
Exemplary Rubber Composition

| Compoment | Wt % |
|---|---|
| 1st Elastomer | 16.10% |
| 2nd Elastomer | 16.10% |
| Carbon Black | 22.53% |
| Filler | 16.10% |
| Plasticizer | 19.88% |
| Curing Agent | 5.60% |
| Blowing Agent | 3.54% |
| Antioxidant | 0.16% |

Table 2 shows another exemplary embodiment of the rubber composition according to the invention.

TABLE 2
Exemplary Rubber Composition

| Additive | Component | Wt % |
|---|---|---|
| Ethylene Propylene Diene | 1st Elastomer | 16.10% |
| Monomer rubber (EPDM) | | |
| Styrene Butadiene Rubber (SBR) | 2nd Elastomer | 16.10% |
| Carbon Black | Carbon Black | 22.53% |
| Calcium Carbonate | Filler | 16.10% |
| Paraffin Oil | Plasticizer | 19.31% |
| Stearic Acid | Plasticizer | 0.57% |
| Zinc Oxide | Curing Agent | 3.22% |
| N-Cyclohexyl-2-Benzothiazole | Curing Agent | 1.06% |
| Sulfenamide (CBS or CZ) | | |
| Diphenylguanidine (DPG) | Curing Agent | 0.68% |
| Sulfur (S) | Curing Agent | 0.64% |
| Calcium Oxide (CaO) | Blowing Agent | 0.32% |
| Azodicarbonamide (ACD) | Blowing Agent | 3.22% |
| Butylated hydroxytoluene (BHT) | Antioxidant | 0.16% |

Table 3 shows another exemplary embodiment of the rubber composition according to the invention.

TABLE 3
Exemplary Rubber Composition

| Component | Wt % |
|---|---|
| 1st Elastomer | 20.60% |
| 2nd Elastomer | 11.59% |
| Carbon Black | 22.53% |
| Filler | 16.10% |
| Plasticizer | 19.88% |
| Curing Agent | 5.60% |
| Blowing Agent | 3.54% |
| Antioxidant | 0.16% |

Table 4 shows an exemplary embodiment of the rubber composition according to the invention.

TABLE 4
Exemplary Rubber Composition

| Additive | Component | Wt % |
|---|---|---|
| Ethylene Propylene Diene | 1st Elastomer | 20.60% |
| Monomer rubber (EPDM) | | |
| Natural Rubber (NR) | 2nd Elastomer | 11.59% |
| Carbon Black | | 22.53% |
| Calcium Carbonate | Filler | 16.10% |
| Paraffin Oil | Plasticizer | 19.31% |
| Stearic Acid | Plasticizer | 0.57% |
| Zinc Oxide | Curing Agent | 3.22% |
| N-Cyclohexyl-2-Benzothiazole | Curing Agent | 1.06% |
| Sulfenamide (CBS or CZ) | | |
| Diphenylguanidine (DPG) | Curing Agent | 0.68% |
| Sulfur (S) | Curing Agent | 0.64% |
| Calcium Oxide (CaO) | Blowing Agent | 0.32% |
| Azodicarbonamide (ACD) | Blowing Agent | 3.22% |
| Butylated hydroxytoluene (BHT) | Antioxidant | 0.16% |

Table 5 shows another exemplary embodiment of the rubber composition according to the invention.

TABLE 5
Exemplary Rubber Composition

| Component | Wt % |
|---|---|
| 1st Elastomer | 20.60% |
| 2nd Elastomer | 11.59% |
| Carbon Black | 22.53% |
| Filler | 16.10% |
| Plasticizer | 19.88 |
| Curing Agent | 5.60% |
| Blowing Agent | 3.54% |
| Antioxidant | 0.16% |

Table 6 shows another exemplary embodiment of the rubber composition according to the invention.

TABLE 6
Exemplary Rubber Composition

| Additive | Component | Wt % |
|---|---|---|
| Ethylene Propylene Diene | 1st Elastomer | 20.60% |
| Monomer rubber (EPDM) | | |
| Styrene Butadiene Rubber (SBR) | 2nd Elastomer | 11.59% |
| Carbon Black | | 22.53% |
| Calcium Carbonate | Filler | 16.10% |
| Paraffin Oil | Plasticizer | 19.31% |
| Stearic Acid | Plasticizer | 0.57% |
| Zinc Oxide | Curing Agent | 3.22% |
| N-Cyclohexyl-2-Benzothiazole | Curing Agent | 1.06% |
| Sulfenamide (CBS or CZ) | | |
| Diphenylguanidine (DPG) | Curing Agent | 0.68% |
| Sulfur (S) | Curing Agent | 0.64% |
| Calcium Oxide (CaO) | Blowing Agent | 0.32% |
| Azodicarbonamide (ACD) | Blowing Agent | 3.22% |
| Butylated hydroxytoluene (BHT) | Antioxidant | 0.16% |

Table 7 shows an exemplary embodiment of the rubber composition according to the invention.

TABLE 7
Exemplary Rubber Composition

| Component | Wt % |
|---|---|
| 1st Elastomer | 34.47% |
| 2nd Elastomer | 8.62% |
| Carbon Black | 13.54% |
| Filler | 17.23% |
| Plasticizer | 13.97% |
| Curing Agent | 6.65% |
| Blowing Agent | 5.09% |
| Antioxidant | 0.43% |

Table 8 shows an exemplary embodiment of the rubber composition according to the invention.

TABLE 8
Exemplary Rubber Composition

| Additive | Component | Wt % |
|---|---|---|
| Chloroprene Rubber (CR) | 1st Elastomer | 34.47% |
| Nitrile Rubber (NBR) | 2nd Elastomer | 8.62% |
| Carbon Black | Carbon Black | 13.54% |
| Calcium Carbonate | Filler | 17.23% |
| Paraffin Oil | Plasticizer | 13.54% |
| Stearic Acid | Plasticizer | 0.43% |
| Zinc Oxide | Curing Agent | 4.31% |
| Magnesium Oxide (MgO) | Curing Agent | 1.72% |
| N-Cyclohexyl-2-Benzothiazole | Curing Agent | 0.54% |
| Sulfenamide (CBS or CZ) | | |
| Diphenylguanidine (DPG) | Curing Agent | 0.09% |
| Sulfur (S) | Blowing Agent | 0.78% |
| Azodicarbonamide (ACD) | Blowing Agent | 4.31% |
| 2,2,4-Thimethyl-1,2-Dihydro- | Antioxidant | 0.43% |
| quinoline Polymer (TMQ) | | |

In another embodiment of the invention, a rubber composition is provided and includes a first elastomer, a second elastomer, a third elastomer, carbon black, a plasticizer, a blowing agent, a filler, a curing agent, and an anti-oxidant agent. The first elastomer is provided in a range of 14.00-15.00 wt %, the second elastomer is provided in a range of 14.00-15.00 wt %, and the third elastomer is provided in a range of 11.00-12.00 wt %. Carbon black is provided in the range of 20.00-23.00 wt %. The plasticizer is provided in a range of 13.70-20.10 wt %. The blowing agent is provided in a range of 4.20-4.40 wt %. The curing agent is provided in a range of 4.50-4.80 wt %. Filler and incidental impurities and elements may be used to complete the composition.

In another exemplary embodiment, a rubber composition according to the invention includes a first elastomer, a second elastomer, a third elastomer, carbon black, a plasticizer, a blowing agent, a filler, a curing agent, and an anti-oxidant agent according to the invention includes a first elastomer, a second elastomer, carbon black, a plasticizer, one or more blowing agents, and a filler.

In an exemplary embodiment of the invention, the rubber composition includes a proportion of 14.00-15.00 wt % of a first elastomer, 14.00-15.00 wt % of a second elastomer, 11.00-12.00 wt % of a third elastomer, 20.00-22.00 wt % of carbon black, 15.50-16.50 wt % of a plasticizer, 4.00-4.50 wt % of a blowing agent, 4.50-5.00 wt % of a curing agent, and a filler completing the composition.

In particular, in an exemplary embodiment of the invention, the rubber composition includes a combination of elastomers. More particularly, the rubber composition includes a combination of saturated and unsaturated rubbers. In the described embodiment, the rubber composition includes a combination of the following group of elastomers, including ethylene propylene diene monomer rubber (EPDM), natural polyisoprene rubber, chloroprene rubber (CR), styrene-butadiene rubber (SBR), high styrene rubber (HSR) and nitrile rubber (NBR). However, one skilled in the art should appreciate that a combination of other saturated and unsaturated rubbers may be possible.

In the proposed rubber composition, an elastomer, such as EPDM, is used to enhance heat-, ozone-, and weather-resistance, as well as electrical insulating properties. In the proposed rubber composition, an addition of a second elastomer, such as natural polyisoprene rubber, is used to enhance elasticity of the rubber composition. In the proposed rubber composition, an addition of a third elastomer, such as HSR, is used to enhance processing, abrasion resistance, tear resistance, and flex resistance.

In particular, in an exemplary embodiment of the invention, the rubber composition includes a first elastomer having a wt % range of 14.00-15.00%. In another exemplary embodiment of the invention, the rubber composition includes a first elastomer having a wt % range of 14.24-14.32%. In yet another exemplary embodiment of the invention, the rubber composition includes a first elastomer having a wt % range of 14.26-14.30%.

In particular, in an exemplary embodiment of the invention, the rubber composition includes a second elastomer having a wt % range of 14.00-15.00%. In another exemplary embodiment of the invention, the rubber composition includes a second elastomer having a wt % range of 14.24-14.32%. In yet another exemplary embodiment of the invention, the rubber composition includes a second elastomer having a wt % range of 14.26-14.30%.

In particular, in an exemplary embodiment of the invention, the rubber composition includes a third elastomer having a wt % range of 11.00-12.00%. In another exemplary embodiment of the invention, the rubber composition includes a first elastomer having a wt % range of 11.39-11.45%. In yet another exemplary embodiment of the invention, the rubber composition includes a first elastomer having a wt % range of 11.41-11.43%.

In the proposed rubber composition, carbon black is used as a pigment and reinforcing material. Also, the carbon black can be used to reduce thermal damage and product viability.

In particular, in an exemplary embodiment of the invention, the rubber composition includes carbon black having a wt % range of 20.00-23.00%. In another exemplary embodiment of the invention, the rubber composition includes carbon black having a wt % range of 20.57-20.67%. And, in yet another exemplary embodiment of the invention, the rubber composition includes carbon black having a wt % of 20.59-20.65%.

In the proposed rubber composition, one or more plasticizers are used to increase the plasticity. In the proposed rubber composition, one or more plasticizers is also used a softener, extender, and lubricant for manufacturing of product from the rubber composition, including an airless tube for a tire. In particular, in an exemplary embodiment of the invention, the rubber composition may include a combination of plasticizers, including paraffinic oil and stearic acid.

In particular, in an exemplary embodiment of the invention, the rubber composition includes one or more plasticizers having a wt % range of 13.70-20.10%. In another exemplary embodiment of the invention, the rubber composition includes plasticizer having a wt % range of 15.95-16.03%. And, in yet another exemplary embodiment of the invention, the rubber composition includes one or more plasticizers having a wt % of 15.97-16.01%.

In the proposed rubber composition, one or more blowing agents may be used to producing a cellular structure that reduces density, increases thermal and acoustic insulation, and increases relative stiffness. In particular, in an exemplary embodiment of the invention, the rubber composition may include one or more blowing agents, including calcium oxide (CaO) and azodicarbonamide (ACD).

In an exemplary embodiment of the invention, the rubber composition includes one or more blowing agents having a wt % range of 4.20-4.40%. In another exemplary embodiment of the invention, the rubber composition includes one or more blowing agents having a wt % range of 4.25-4.35%. And, in yet another exemplary embodiment of the invention, the rubber composition includes one or more blowing agents having a wt % of 4.27-4.29%.

In the proposed rubber composition, a curing agent may be used to toughen or harden the overall composition by cross-linking of polymer chains, using processes such as vulcanization. In an exemplary embodiment of the invention, the rubber composition may include one or more curing agents, including zinc oxide, n-cyclohexyl-2-benzothiazole sulfenamide (CBS), diphenylguanidine (DPG), and sulfur (S).

In an exemplary embodiment of the invention, the rubber composition includes one or more curing agents having a wt % range of 4.50-4.80%. In another exemplary embodiment of the invention, the rubber composition includes one or more curing agents having a wt % range of 4.60-4.75%. And, in yet another exemplary embodiment of the invention, the rubber composition includes one or more curing agents having a wt % of 4.70-4.72%.

In the proposed rubber composition, filler is used to complete the composition with respect to the other parts. In particular, in an exemplary embodiment of the invention, the rubber composition may include calcium carbonate as a filler. In the proposed rubber composition, calcium carbonate may have a wt % range of 14.20-14.40%. In another exemplary embodiment of the invention, the rubber composition includes filler having a wt % range of 14.24-14.32%. In yet another exemplary embodiment of the invention, the rubber composition includes filler having a wt % range of 14.26-14.30%.

The rubber composition according to the invention may also include an antioxidant agent.

In the proposed rubber composition, the antioxidant is used to prevent oxidation. In an exemplary embodiment of the invention, the rubber composition may include one or more antioxidants, including butylated hydroxytoluene (BHT) and/or 2,2,4-trimethyl-1,2-dihydroquinoline polymer (TMQ).

In the proposed rubber composition, one or more antioxidants may have a wt % range of 0.10-0.20%. In another exemplary embodiment of the invention, the rubber composition includes one or more antioxidants having a wt % range of 0.12-0.15%. In yet another exemplary embodiment of the invention, the rubber composition includes one or more antioxidants having a wt % range of 0.13-0.14%.

The present invention can be illustrated by the following examples without being limited by them. Each of the following examples was prepared being dependent on a required size of the airless tire tube according to the invention.

Table 9 shows an exemplary embodiment of the rubber composition.

TABLE 9
Exemplary Rubber Composition

| Component | Wt % |
|---|---|
| 1st Elastomer | 14.26% |
| 2nd Elastomer | 14.26% |
| 3rd Elastomer | 11.41% |
| Carbon Black | 20.59% |
| Filler | 14.26% |
| Plasticizer | 15.97% |
| Curing Agent | 4.70% |
| Blowing Agent | 4.27% |
| Antioxidant | 0.14% |

Table 10 shows another exemplary embodiment of the rubber composition according to the invention.

TABLE 10
Exemplary Rubber Composition

| Additive | Component | Wt % |
|---|---|---|
| Ethylene Propylene Diene | 1st Elastomer | 14.26% |
| Monomer rubber (EPDM) | | |
| Natural polyisoprene rubber | 2nd Elastomer | 14.26% |
| High Styrene Rubber | 3rd Elastomer | 11.41% |
| Carbon Black | Carbon Black | 20.59% |
| Calcium Carbonate | Filler | 14.26% |
| Paraffin Oil | Plasticizer | 15.97% |
| Stearic Acid | Plasticizer | |
| Zinc Oxide | Curing Agent | 4.70% |
| N-Cyclohexyl-2-Benzothiazole | Curing Agent | |
| Sulfenamide (CBS or CZ) | | |
| Diphenylguanidine (DPG) | Curing Agent | |
| Sulfur (S) | Curing Agent | |
| Calcium Oxide (CaO) | Blowing Agent | 4.27% |
| Azodicarbonamide (ACD) | Blowing Agent | |
| Butylated hydroxytoluene (BHT) | Antioxidant | 0.14% |

Table 11 shows another exemplary embodiment of the rubber composition according to the invention.

TABLE 11
Exemplary Rubber Composition

| Component | Wt % |
|---|---|
| 1st Elastomer | 14.30% |
| 2nd Elastomer | 14.30% |
| 3rd Elastomer | 11.43% |
| Carbon Black | 20.65% |
| Filler | 14.30% |
| Plasticizer | 16.01% |
| Curing Agent | 4.72% |
| Blowing Agent | 4.29% |
| Antioxidant | 0.14% |

Table 12 shows an exemplary embodiment of the rubber composition according to the invention.

TABLE 12
Exemplary Rubber Composition

| Additive | Component | Wt % |
|---|---|---|
| Ethylene Propylene Diene | 1st Elastomer | 14.30% |
| Monomer rubber (EPDM) | | |
| Natural polyisoprene rubber | 2nd Elastomer | 14.30% |
| High Styrene Rubber | 3rd Elastomer | 11.43% |
| Carbon Black | Carbon Black | 20.65% |
| Calcium Carbonate | Filler | 14.30% |
| Paraffin Oil | Plasticizer | 16.01% |
| Stearic Acid | Plasticizer | |
| Zinc Oxide | Curing Agent | 4.72% |
| N-Cyclohexyl-2-Benzothiazole | Curing Agent | |
| Sulfenamide (CBS or CZ) | | |
| Diphenylguanidine (DPG) | Curing Agent | |
| Sulfur (S) | Curing Agent | |
| Calcium Oxide (CaO) | Blowing Agent | 4.29% |
| Azodicarbonamide (ACD) | Blowing Agent | |
| Butylated hydroxytoluene (BHT) | Antioxidant | 0.14% |

Table 13 shows another exemplary embodiment of the rubber composition according to the invention.

TABLE 13
Exemplary Rubber Composition

| Component | Wt % |
|---|---|
| 1st Elastomer | 14.28% |
| 2nd Elastomer | 14.28% |
| 3rd Elastomer | 11.42% |
| Carbon Black | 20.62% |
| Filler | 14.28% |
| Plasticizer | 15.99% |
| Curing Agent | 4.71% |
| Blowing Agent | 4.28% |
| Antioxidant | 0.14% |

Table 14 shows another exemplary embodiment of the rubber composition according to the invention.

TABLE 14
Exemplary Rubber Composition

| Additive | Component | Wt % |
|---|---|---|
| Ethylene Propylene Diene | 1st Elastomer | 14.28% |
| Monomer rubber (EPDM) | | |
| Natural polyisoprene rubber | 2nd Elastomer | 14.28% |
| High Styrene Rubber | 3rd Elastomer | 11.42% |
| Carbon Black | Carbon Black | 20.62% |
| Calcium Carbonate | Filler | 14.28% |
| Paraffin Oil | Plasticizer | 15.99% |
| Stearic Acid | Plasticizer | |
| Zinc Oxide | Curing Agent | 4.71% |
| N-Cyclohexyl-2-Benzothiazole | Curing Agent | |
| Sulfenamide (CBS or CZ) | | |
| Diphenylguanidine (DPG) | Curing Agent | |
| Sulfur (S) | Curing Agent | |
| Calcium Oxide (CaO) | Blowing Agent | 4.28% |
| Azodicarbonamide (ACD) | Blowing Agent | |
| Butylated hydroxytoluene (BHT) | Antioxidant | 0.14% |

In an exemplary description of manufacturing, a rubber composition according to the invention is processed according to the following steps. However, one skilled in the art should appreciate that following steps are merely exemplary and used to enable one skilled in the art to process the proposed rubber compositions according to the invention.

Firstly, the components of the rubber composition are measured according to the specifications defined above.

In an embodiment of the invention, a first combination of the first elastomer, the second elastomer, carbon black, one or more plasticizers, and the filler is mixed using a closed mixing system.

Next, the first combination is moved to an open mixing system where other components are added, including one or more curing agents, one or more blowing agents, and one or more antioxidants. The components mixed with the first combination provide a batch of the rubber composition for further processing.

The batch is then added to an extruder for extrusion. The batch is extruded to a profile and size required for an airless tire tube according to the invention. The batch travels along a chamber that is heated at different temperatures along different zones by a screw. In an embodiment of the invention, the first zone is heated to a temperature ranging from 200-220° C., the second zone is heated to a temperatures ranging from 160-185° C., and the third zone is heated to a temperature ranging from 170-190° C.

After the batch has been sheared and heated, the batch then travels through a die providing a profile of the airless tire tube according to the invention. A jig is used to cut a length of the extruded rubber composition, wherein the length and profile depend on the particular manufacturing-based required specifications of the airless tire tube according to the invention. The cut is performed on a 45 degree or a 90 degree angle with respect to an outer surface of the extruded material.

After cutting, a solid cylindrical section is provided with opposite ends having a 45 degree or 90 degree profile. The opposite ends are then joined using a compression machine and the solid cylindrical section is formed into a solid ring of the rubber composition according to the invention, which is an airless tire tube according to the invention.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

What is claimed is:

1. A rubber composition for an airless tire tube, comprising:
14.00-15.00 wt % of a first elastomer;
14.00-15.00 wt % of a second elastomer;
11.00-12.00 wt % of a third elastomer;
20.00-23.00 wt % of carbon black;
13.70-20.10 wt % of a plasticizer;
4.20-4.40 wt % of a blowing agent; and
a balance of a filler and incidental impurities.

2. The rubber composition according to claim 1, wherein the first elastomer is a saturated or unsaturated rubber.

3. The rubber composition according to claim 2, wherein the second elastomer is a saturated or unsaturated rubber.

4. The rubber composition according to claim 3, wherein the third elastomer is a saturated or unsaturated rubber.

5. The rubber composition according to claim 4, wherein the first elastomer and the second elastomer are selected from a group of elastomers, consisting of: an ethylene propylene diene monomer rubber (EPDM), a natural polyisoprene rubber, a chloroprene rubber (CR), a styrene-butadiene rubber (SBR), and a nitrile rubber (NBR).

6. The rubber composition according to claim 1, wherein the first elastomer is an ethylene propylene diene monomer rubber (EPDM).

7. The rubber composition according to claim 6, wherein the second elastomer is a natural polyisoprene rubber.

8. The rubber composition according to claim 7, wherein the third elastomer is a high styrene rubber.

9. The rubber composition according to claim 1, wherein the first elastomer is 14.24-14.32 wt %.

10. The rubber composition according to claim 9, wherein the first elastomer is 14.26-14.30 wt %.

11. The rubber composition according to claim 1, wherein the second elastomer is 14.24-14.32 wt %.

12. The rubber composition according to claim 11, wherein the second elastomer is 14.26-14.30 wt %.

13. The rubber composition according to claim 1, wherein the third elastomer is 11.39-11.45 wt %.

14. The rubber composition according to claim 13, wherein the third elastomer is 11.41-11.43 wt %.

15. The rubber composition according to claim 1, wherein the carbon black is 20.57-20.67 wt %.

16. The rubber composition according to claim 15, wherein the carbon black is 20.59-20.65 wt %.

17. The rubber composition according to claim 1, wherein the plasticizer is 15.95-16.03 wt %.

18. The rubber composition according to claim 17, wherein the plasticizer is 15.97-16.01%.

19. The rubber composition according to claim 1, wherein the blowing agent is 4.25-4.35%.

20. The rubber composition according to claim 20, wherein the blowing agent is 4.27-4.29%.

21. The rubber composition according to claim 1, further comprising a curing agent having a wt % range of 4.50-4.80%.

22. The rubber composition according to claim 21, wherein the curing agent is 4.60-4.75%.

23. The rubber composition according to claim 21, wherein the curing agent is 4.70-4.72%.

24. The rubber composition according to claim 1, wherein the filler is 14.24-14.32 wt %.

25. The rubber composition according to claim 24, wherein the filler is 14.26-14.30 wt %.

26. The rubber composition according to claim 1, wherein the filler is calcium carbonate.

27. The rubber composition according to claim 1, further comprising an antioxidant agent having a wt % range of 0.10-0.20%.

28. The rubber composition according to claim 27, wherein the antioxidant agent is 0.12-0.15 wt %.

29. The rubber composition according to claim 28, wherein the antioxidant agent is 0.13-0.14 wt %.

30. A rubber composition for an airless tire tube, comprising:
15.97-34.71 wt % of a first elastomer;
8.37-16.22 wt % of a second elastomer;
13.29-23.00 wt % of carbon black;
13.71-20.02 wt % of a plasticizer;
3.22-5.11 wt % of a blowing agent; and
a balance of a filler and incidental impurities.

31. The rubber composition according to claim 30, wherein the first elastomer is a saturated or unsaturated rubber.

32. The rubber composition according to claim 31, wherein the second elastomer is a saturated or unsaturated rubber.

33. The rubber composition according to claim 32, wherein the first elastomer and the second elastomer are selected from a group of elastomers, consisting of: an ethylene propylene diene monomer rubber (EPDM), a natural polyisoprene rubber, a chloroprene rubber (CR), a styrene-butadiene rubber (SBR), and a nitrile rubber (NBR).

34. The rubber composition according to claim 30, wherein the first elastomer is an ethylene propylene diene monomer rubber (EPDM).

35. The rubber composition according to claim 34, wherein the second elastomer is a styrene-butadiene rubber (SBR).

36. The rubber composition according to claim 34, wherein the second elastomer is a natural polyisoprene rubber.

37. The rubber composition according to claim 30, wherein the first elastomer is a chloroprene rubber (CR).

38. The rubber composition according to claim 37, wherein the second elastomer is a styrene-butadiene rubber (SBR).

39. The rubber composition according to claim 37, wherein the second elastomer is a nitrile rubber (NBR).

40. The rubber composition according to claim 30, wherein the first elastomer is 15.97-20.73 wt %.

41. The rubber composition according to claim 40, wherein the first elastomer is 20.47-20.73 wt %.

42. The rubber composition according to claim 30, wherein the second elastomer 8.37-16.22 wt %.

43. The rubber composition according to claim 42, wherein the second elastomer is 11.46-16.22 wt %.

44. The rubber composition according to claim 30, wherein the blowing agent includes calcium oxide (CaO).

45. The rubber composition according to claim 44, wherein the blowing agent further includes azodicarbonamide (ACD).

46. The rubber composition according to claim 45, wherein the blowing agent is 3.22-5.11% wt %.

47. The rubber composition according to claim 46, wherein the blowing agent is 3.53-3.55 wt %.
